(19) United States
(12) Patent Application Publication
(10) Pub. No.: US 2016/0185329 A1
(43) Pub. Date: Jun. 30, 2016

(54) ELECTRIC BRAKE DEVICE

(71) Applicant: MANDO CORPORATION, Gyeonggi-do (KR)

(72) Inventors: Chanhui LEE, Seongnam-si (KR); Young Song LEE, Ansan-si (KR)

(73) Assignee: MANDO CORPORATION, Gyeonggi-do (KR)

(21) Appl. No.: 14/981,916

(22) Filed: Dec. 29, 2015

(30) Foreign Application Priority Data
Dec. 29, 2014 (KR) 10-2014-0192672

(51) Int. Cl. B60T 13/16; B60T 8/40; B60T 13/68

(52) U.S. Cl. CPC B60T 13/165; B60T 13/686; B60T 8/4081

(57) ABSTRACT

An electric integrated brake device according to an embodiment of the present invention includes a master cylinder that generates a hydraulic pressure based on the operation of a pedal, a pedal simulator that provides a pedal stepping force to the pedal based on the hydraulic pressure, a motor that is driven based on the displacement of the pedal, a pump that applies a braking pressure to a wheel cylinder arranged at a wheel side of the vehicle based on the operation of the motor, a valve block that includes a plurality of solenoid valves for opening and closing the flow of oil moving among the master cylinder, the pedal simulator, the pump, and the wheel cylinder, and an ECU (electronic control unit) that controls the motor and the valve block, wherein the master cylinder, the pedal simulator, the motor, the pump, the valve block, and the ECU are integrated into a single structure.

### CROSS-REFERENCE TO RELATED APPLICATION

This application claims priority to and the benefit of Korean Patent Application No. 10-2014-0192672, filed on Dec. 29, 2014, the disclosure of which is incorporated herein by reference in its entirety.

### BACKGROUND

1. Field of the Invention

The present invention relates to an electric brake device, and more particularly, to an electric brake device, which may reduce the overall size and weight of a brake device to reduce the manufacturing costs, and may improve the mountability within the vehicle to facilitate the layout design.

2. Discussion of Related Art

In recent years, the development of hybrid vehicles, fuel cell vehicles, electric vehicles, and the like has been actively conducted in order to improve fuel efficiency and reduce emissions.

In these vehicles, a brake system, that is, a brake device for a vehicle is essentially installed, where the brake device for the vehicle refers to a device that functions to stop a running vehicle or reduce the speed thereof.

As examples of a typical brake device for a vehicle, a vacuum brake which generates a braking force using suction pressure of a vehicle engine and a hydraulic brake which generates a braking force using hydraulic pressure may be given.

The vacuum brake is a device that enables a vacuum booster to exert a large braking force with a small force by using a pressure difference between the suction pressure of the vehicle engine and the atmospheric pressure. That is, the vacuum brake refers to a device that generates a much greater output than the force applied to a brake pedal when a driver steps on the brake pedal.

Such a conventional vacuum brake has a problem that the suction pressure of the vehicle engine should be supplied to the vacuum booster in order to form vacuum, and thereby the fuel efficiency is reduced. In addition, the conventional vacuum brake also has a problem that the engine should be continuously driven in order to form vacuum even when the vehicle is stopped.

In addition, in cases of the fuel cell vehicle and the electric vehicle, there is no engine, and thereby it is impossible to apply an existing vacuum brake for amplifying a pedal stepping force of the driver when the vehicle is braked, and in a case of the hybrid vehicle, an idle stop function should be implemented when the vehicle is stopped in order to improve the fuel efficiency, and thereby the introduction of a hydraulic brake is required.

That is, as described above, in all vehicles, regenerative braking implementation is required in order to improve the fuel efficiency, and therefore the function of a hydraulic brake may be easily implemented at the time of the introduction of the hydraulic brake.

Meanwhile, an electro-hydraulic brake system which is a kind of the hydraulic brake is a brake system in which an electronic control unit detects, when a driver steps on a pedal, this, and a brake hydraulic pressure is transmitted to the wheel cylinder (not shown) of each wheel to thereby generate a braking force.

A brake device of such an electro-hydraulic brake system is configured and used in a manner that facilitates its control, but there is a demand for an advanced electro-hydraulic brake system in which user requirements such as securing safety of a vehicle when the vehicle is braked, improving fuel efficiency, providing a proper pedal feel, and the like can be achieved.

Therefore, in response to the requirements, a research to develop an electric brake system that has a simple configuration, has excellent mountability within a vehicle and excellent lay-out design, and generates a dynamic braking force is being conducted.

### SUMMARY OF THE INVENTION

The present invention is directed to an electric brake device in which components such as a master cylinder, a pedal simulator, a valve block for performing an existing ESC (electronic stability control) function, an ECU (electronic control unit), a pump, and the like may be integrated into a single system unit, so that the conventional ABS (anti-lock braking system) and CBS (conventional brake system) functions may be performed through the single system unit, and the size and weight of the electric brake device may be reduced compared to a conventional master booster, thereby improving the mountability within the vehicle and securing the ease of lay-out design.

According to an aspect of the present invention, there is provided an electric integrated brake device including: a master cylinder that generates a hydraulic pressure based on the operation of a pedal, a pedal simulator that provides a pedal stepping force to the pedal based on the hydraulic pressure, a motor that is driven based on the displacement of the pedal, a pump that applies a braking pressure to a wheel cylinder arranged at a wheel side of the vehicle based on the operation of the motor, a valve block that includes a plurality of solenoid valves for opening and closing the flow of oil moving among the master cylinder, the pedal simulator, the pump, and the wheel cylinder, and an ECU (electronic control unit) that controls the motor and the valve block, wherein the master cylinder, the pedal simulator, the motor, the pump, the valve block, and the ECU are integrated into a single structure.

Preferably, the valve block may include a first body and a second body that is formed below the first body and extends perpendicularly with respect to the first body.

Preferably, one side surface of the first body may be arranged to be in contact with an upper portion of one side surface of the ECU, and a side surface of the motor may be arranged to be adjacent to a lower portion of the one side surface of the ECU.

Preferably, an upper portion of the motor may be arranged to be in contact with a lower portion of the second body.

Preferably, the motor may be formed as a hollow motor for accommodating a piston of the pump therein, and the pump may be arranged to be in contact with an upper portion of the second body while a rotational axial direction of the motor serves as a longitudinal direction.

Preferably, the pump and the master cylinder may be arranged to be in contact with an upper portion of the second body, one side surface of the master cylinder may be arranged so as to be spaced apart from the other side surface of the first body, and the pump may be arranged between the first body and the master cylinder.

Preferably, a reservoir that stores oil may be arranged to be above the master cylinder.

Preferably, the reservoir may be detachably mounted.

Preferably, the pedal simulator may be arranged to be in contact with the other side surface of the master cylinder.

Preferably, the electric integrated brake device may further include an input rod that connects the pedal to the master cylinder and transmits the pressure of the pedal to the master cylinder.

Preferably, the master cylinder, the valve block, and the motor may be sequentially arranged from top to bottom to be coupled together, and the pedal simulator and the ECU may be arranged in mutually opposed directions facing each other to be respectively coupled to the master cylinder and the valve block.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a perspective view of an electric brake device according to an embodiment of the present invention;

FIG. 2 is a front view of the electric brake device shown in FIG. 1;

FIG. 3 is a left side view of the electric brake device shown in FIG. 1; and

FIG. 4 is a right side view of the electric brake device shown in FIG. 1.

### DETAILED DESCRIPTION OF EXEMPLARY EMBODIMENTS

Hereinafter, preferred embodiments of the present invention will be described in detail with the accompanying drawings.

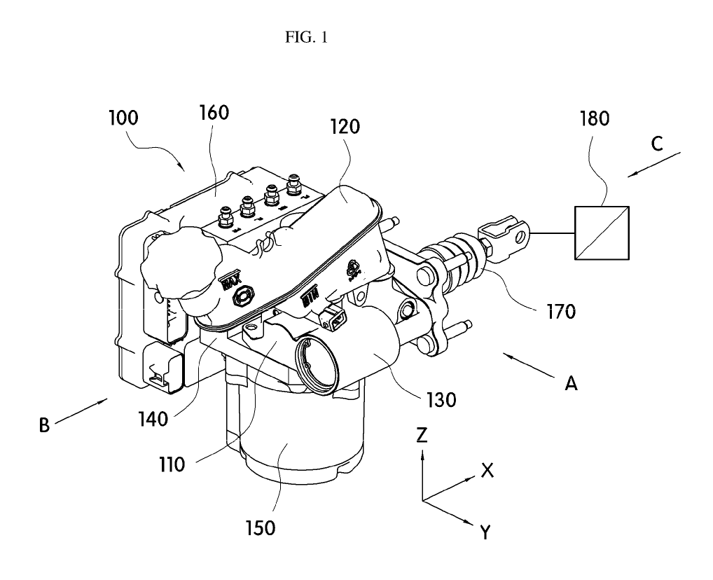

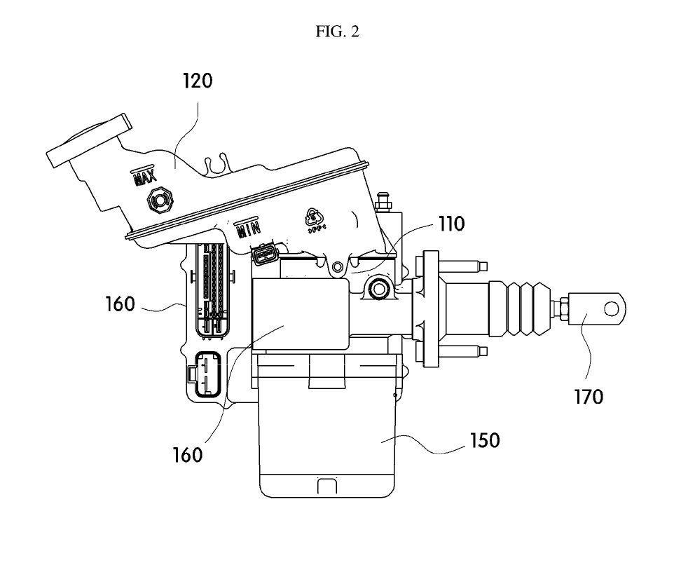

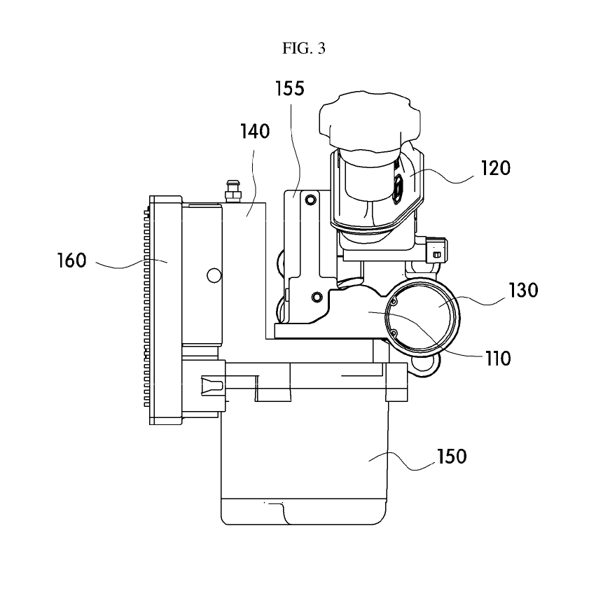

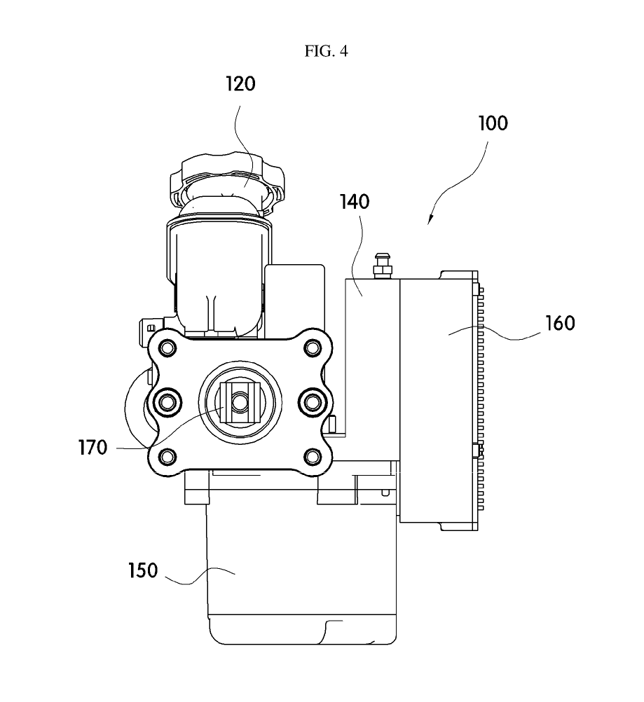

FIG. 1 is a perspective view of an electric integrated brake device according to an embodiment of the present invention, and FIG. 2 is a front view (direction A) of the electric integrated brake device of FIG. 1. FIGS. 3 and 4 are a left side view (direction B) and a right side view (direction C) respectively of the electric integrated brake device shown in FIG. 1.

As shown in FIGS. 1 to 4, the electric integrated brake device according to an embodiment of the present invention may roughly include a master cylinder 110, a pedal simulator 130, a motor 150, a pump 155, a valve block 140, and an ECU (electronic control unit) 160.

The master cylinder 110 that is a component for generating a hydraulic pressure based on the operation of a brake pedal (not shown) by a driver may include two pistons provided therein so as to have two hydraulic circuits, and when a pressure is applied to the brake pedal, the pressure may be transmitted through an input rod 170 that is arranged coaxially with the piston, so that the hydraulic pressure may be generated.

The pedal simulator 130 is a component for providing a pedal stepping force to the pedal based on the hydraulic pressure generated by the master cylinder 110. Specifically, the pedal simulator 130 includes a chamber having a piston and a spring therein, and when a pressure is applied to the brake pedal, a pressure generated by the movement of the input rod 170 may enable the piston to be moved and the spring to be elastically compressed. When the pressure applied to the brake pedal is released, the stepping force may be provided to the input rod 170 by an elastic force compressed by the spring, so that an appropriate pedal feel may be provided to a driver.

The motor 150 is a component that is driven based on the displacement of the pedal, and specifically, when a movement angle or a movement displacement of the pedal which are detected by a stroke sensor are input to the ECU 160 which will be described later, the ECU 160 may supply a current corresponding to the input movement angle or movement displacement to the motor 150, so that the motor 150 may be rotated.

The pump 155 performs a function of applying a braking pressure to wheel cylinders arranged on a wheel side of the vehicle based on the operation of the motor 150. Thus, the pump 155 includes a chamber and a piston performing a linear reciprocating motion within the chamber, and a separate member for converting a rotating motion of the motor 150 into a linear motion is required. For example, the rotating motion of the motor 150 may be converted into the linear motion using a pinion and a rack bar, and the rotating motion may be converted into the linear motion using a ball-screw method. A valve block 140 may include the master cylinder 110, the pedal simulator 130, the pump 155, and flow passages respectively connected to the wheel cylinders provided therein, and a plurality of solenoid valves for opening and closing the flow of oil may be provided on the inner flow passages.

That is, the solenoid valves required for the operation of the conventional ABS (anti-lock braking system) or ESC (electronic stability control) may be mounted in the valve block 140, and operated by electrical signals input from the ECU 160 to regulate the flow of oil. Such a valve block 140 may be divided into a first body and a second body as shown in FIGS. 1 to 4, and the second body may be formed below the first body in such a manner as to extend in a direction perpendicular to the first body.

The ECU 160 is a component for controlling the above-described motor 150 and valve block 140.

According to the electric brake device according to an embodiment of the present invention, the above-described master cylinder 110, pedal simulator 130, motor 150, pump 155, valve block 140, and ECU 160 may be integrated into a single system unit. Hereinafter, a method in which the above-described individual components are arranged and combined will be described in detail.

First, when it is assumed that the ECU 160 is arranged perpendicular to a Y-axis of FIG. 1, one side surface of the first body of the valve block 140 may be arranged to be in contact with an upper portion of one side surface of the ECU 160, and a side surface of the motor 150 may be arranged to be adjacent to a lower portion of the one side surface of the ECU 160. At the same time, an upper portion of the motor 150 may be arranged to be in contact with a lower portion of the second body.

The pump 155 may be arranged to be in contact with an upper portion of the second body of the valve block 140 while the rotational axial direction of the motor 150 serves as the longitudinal direction. That is, the pump 155, an upper surface of the valve block 140, and the motor 150 may be arranged to be vertically coupled together. For the coupling of such a structure, the motor 150 is required to be formed as a hollow motor for accommodating the piston of the pump 155 therein, and the valve block 140 may be also required to have a hollow for the movement of the piston of the pump 155. In addition, the rotating motion of the motor 150 may be converted into a linear motion by a ball-screw method, so that the piston within the pump 155 may perform a linear reciprocating motion within the chamber.

Meanwhile, the master cylinder 110 may be also arranged to be in contact with the upper portion of the second body of the valve block 140 in the similar manner to that in the pump 155, and in this case, it is preferable that one side surface of the master cylinder 110 be arranged so as to be spaced apart from the other side surface of the first body of the valve block 140 and the pump 155 be arranged between the first body and the master cylinder 110.

In addition, the electric brake device according to an embodiment of the present invention may further include a reservoir 120 that stores oil, and such a reservoir 120 may be detachably arrange on the upper side of the master cylinder 110.

The pedal simulator 130 may be arranged to be in contact with the other side surface of the master cylinder 110, and specifically, the master cylinder 110 may be coupled adjacent to the pump 155 on one side thereof and the pedal simulator 130 on the other side thereof.

In addition, the electric brake device according to an embodiment of the present invention may further include the input rod 170, and such an input rod 170 may connect the pedal to the master cylinder 110 and transmit the pressure of the pedal to the master cylinder 110.

Consequently, in the electric integrated brake device according to an embodiment of the present invention, the master cylinder 110, the valve block 140, and the motor 150 may be sequentially arranged from top to bottom to be coupled together, and the pedal simulator 130 and the ECU 160 may be arranged in mutually opposed directions facing each other to be respectively coupled to the master cylinder 110 and the valve block 150.

As described above, the master cylinder 110, the pedal simulator 130, the motor 150, the pump 155, the valve block 140, and the ECU 160 may be integrated into a single structure, so that the volume (size) and weight of the electric integrated brake device may be reduced compared to a conventional master booster, and ABS and CBS functions may be performed by a single electric integrated brake device.

As described above, according to the electric brake device according to the embodiments of the present invention, the existing ECU, master cylinder, pedal simulator, valve block, motor, pump, and the like may be integrated into a single structure, so that the size and weight of the electric brake device may be significantly reduced compared to an existing master booster, thereby improving the mountability within the vehicle and facilitating the lay-out design within the vehicle. In addition, the ABS and CBS functions may be performed by the single integrated system.

In addition, a brake hydraulic line may be formed using only four pipes connected to each of the wheels in the vehicle, and the electric integrated brake device may be designed in a motor based power-on-demand method, making it possible to realize a linear and dynamic brake feel.

In addition, the electric integrated brake device according to the embodiments of the present invention may have an improved responsiveness and causes less noise than those of an existing conventional brake device, so that it is possible to realize a variable brake feel depending on a driver's preference.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An electric integrated brake device comprising:
a master cylinder that generates a hydraulic pressure based on the operation of a pedal;
a pedal simulator that provides a pedal stepping force to the pedal based on the hydraulic pressure;
a motor that is driven based on the displacement of the pedal;
a pump that applies a braking pressure to a wheel cylinder arranged at a wheel side of the vehicle based on the operation of the motor;
a valve block that includes a plurality of solenoid valves for opening and closing the flow of oil moving among the master cylinder, the pedal simulator, the pump, and the wheel cylinder; and
an ECU (electronic control unit) that controls the motor and the valve block,
wherein the master cylinder, the pedal simulator, the motor, the pump, the valve block, and the ECU are integrated into a single structure.

2. The electric integrated brake device of claim 1, wherein the valve block includes a first body and a second body that is formed below the first body and extends perpendicularly with respect to the first body.

3. The electric integrated brake device of claim 2, wherein one side surface of the first body is arranged to be in contact with an upper portion of one side surface of the ECU and a side surface of the motor is arranged to be adjacent to a lower portion of the one side surface of the ECU.

4. The electric integrated brake device of claim 3, wherein an upper portion of the motor is arranged to be in contact with a lower portion of the second body.

5. The electric integrated brake device of claim 4, wherein the motor is formed as a hollow motor for accommodating a piston of the pump therein, and the pump is arranged to be in contact with an upper portion of the second body while the rotational axial direction of the motor serves as the longitudinal direction.

6. The electric integrated brake device of claim 4, wherein the pump and the master cylinder are arranged to be in contact with an upper portion of the second body, one side surface of the master cylinder is arranged to be spaced apart from the other side surface of the first body, and the pump is arranged between the first body and the master cylinder.

7. The electric integrated brake device of claim 6, wherein a reservoir that stores oil is arranged to be above the master cylinder.

8. The electric integrated brake device of claim 7, wherein the reservoir is detachably mounted.

9. The electric integrated brake device of claim 6, wherein the pedal simulator is arranged to be in contact with the other side surface of the master cylinder.

10. The electric integrated brake device of claim 1, further comprising:
an input rod that connects the pedal to the master cylinder and transmits the pressure of the pedal to the master cylinder.

11. The electric integrated brake device of claim 1, wherein the master cylinder, the valve block, and the motor are sequentially arranged from top to bottom to be coupled together, and the pedal simulator and the ECU are arranged in mutually opposed directions facing each other to be respectively coupled to the master cylinder and the valve block.
